(19) United States
(12) Patent Application Publication
(10) Pub. No.: US 2025/0044757 A1
(43) Pub. Date: Feb. 6, 2025

(54) CONTROLLER FOR A HOUSEHOLD APPLIANCE

(71) Applicant: BSH Hausgeräte GmbH, München (DE)

(72) Inventors: Martin Winkler, Nittenau (DE); Kai Achim Kropp, Wald (DE)

(21) Appl. No.: 18/709,052

(22) PCT Filed: Feb. 2, 2023
(86) PCT No.: PCT/EP2023/052533

§ 371 Date: May 10, 2024

(30) Foreign Application Priority Data
Feb. 17, 2022 (DE) 10 2022 201 643.2

(51) Int. Cl. G05B 19/042

(52) U.S. Cl. CPC G05B 19/042; G05B 2219/23238

(57) ABSTRACT

A control component for a household appliance has an interface for a data connection to a further control component of the household appliance; a detector for a predetermined signal on the data connection, the signal being different from data that can be transmitted between two control components; an input for a supply voltage; and a first output for enabling control of a function of the household appliance in dependence upon a voltage that is present at the input.

The invention relates to the control of a household appliance. In particular the invention relates to the control of an energy consumption of the household appliance.

A household appliance comprises a control device which is designed to control various components of the household appliance. For example, the household appliance can comprise a refrigerator, wherein a first component comprises a coolant compressor and a second component comprises a user interface.

The control device can support different modes, in which it is differently active. In a sleep or standby mode for example the interface can be shut down to the extent that it accepts only a single input, which is used to exit standby mode. In a normal or operating mode all functions of the user interface can be available. If no input is made for a predetermined time, the control device can be automatically switched to standby mode.

Modern household appliances often contain multiple control devices, and not all of them are designed to control a function that permits different modes. Accordingly, some control devices of such a household appliance are likewise not designed for an energy-saving standby mode. These control devices May consume more electrical energy than is necessary for the performance of the function of the household appliance. Even if the difference in energy consumed between a standby mode and an operating mode is small, a significant amount of electrical energy can be consumed unnecessarily when there are a large number of household appliances in a household. When there is an entire fleet of identical household appliances installed in different households, a large amount of electrical energy can potentially be saved.

One object underlying the present invention consists in specifying an improved energy-saving control for a household appliance. The invention achieves this object by means of the subject matters of the independent claims. Subclaims reflect preferred forms of embodiment.

According to a first aspect of the present invention a control component for a household appliance comprises an interface for a data connection to a further control component of the household appliance; a detector for a predetermined signal on the data connection, the signal being different from data that can be transmitted between two control components; an input for a supply voltage; and a first output for enabling control of a function of the household appliance in dependence upon a voltage present at the input.

The control component can be operated in different modes, in which the household appliance consumes different amounts of electrical energy. In a first mode, which is here also referred to as the normal operating mode, the control can be enabled. In a second mode, which is here also referred to as the sleep or standby mode, the control of the function of the household appliance can be restricted or suspended. A transition from standby mode to operating mode can take place if the signal is detected on the data connection.

Multiple control components can be connected to one another, in order to synchronize their modes with one another. In this case the control components can control different functions of the household appliance. By means of the data connection, data for the control of the household appliance can be transmitted between different control components. In standby mode the control component cannot send messages and/or cannot evaluate messages on the data connection. The signal can be transmitted outside a transmission of data. In particular, the signal can also then be detected by a control component which is in standby mode.

The control component can comprise a second output for a supply voltage for the further control component and can be designed to provide a high or a low voltage at the second output. The high voltage can be sufficient to operate a connected microprocessor or microcontroller and can for example be 5 V. The low voltage can keep the microcomputer or microcontroller in an energy-saving standby mode and can for example be 3.3 V or 2.7 V. The voltage provided preferably follows the supply voltage.

Further preferably, the high voltage is provided if the control component is in the first mode, and the low voltage if it is in the second mode. A transition between both the modes may require a predetermined voltage change at the input and/or a predetermined message on the data connection.

A generator for the signal on the data connection is optionally provided in dependence upon a predetermined condition. Thus the control component can switch one or more connected control components from the second mode to the operating mode and in this way “wake them up”.

In a preferred form of embodiment a first control component is designed to control a mode for itself and one or more further, second control components. The first control component can to this end control the supply voltage of the second control components as high or low. A second control component can request a transition from standby mode to operating mode, by applying the predetermined signal to the data connection. The first control component can receive the signal and increase the supply voltage for the second control components (and for itself), in order to initiate the operating mode.

Further, a detector to capture a signal that represents the fulfillment of the condition can be included in the control component. Such a line is also known as an interrupt line and can be sampled even if the control component is in standby mode. Thus it is possible to switch from standby mode to operating mode if the line changes in a predetermined manner from a low to a high level or vice versa, this being known as edge control, or if the line assumes a predetermined low or high level for a predetermined time, this being known as level control.

Additionally, a voltage control can be included for the provision of a supply voltage for the control of the function on the basis of the supply voltage present at the input. The voltage control for the control of the function can be synchronized with the control of the supply voltage for other control components. The voltage controller is optionally implemented as an external component of the control component and is controlled by the control component to provide a high or a low voltage.

In a first form of embodiment an external control device can be requested, by means of the supply voltage, to assume the first or second mode. In this case the supply voltage provided to the external control device can be understood as a signal and any assignment of voltages to modes to be assumed can be predetermined.

In a second form of embodiment the voltage control can be designed to provide a high or a low voltage in order to supply it to an external control device that controls the function. The function can be restricted or disabled by providing the low voltage.

The data connection can comprise a serial connection. For example, a data connection in accordance with RS-232 can be installed between two control components. If a control component is to be able to send information to multiple other control components, a data connection in accordance with RS-422 can be installed. Further, a data connection in accordance with RS-485 can alternatively be installed in order to support multiple transmitters and multiple receivers.

Further preferably, the data connection comprises a bus, in particular a serial bus. The bus can be operated in accordance with any known specification. Multiple control components can preferably be connected to the bus, wherein the control components can further preferably be addressed on the bus. In all cases the signal is preferably transmitted not as a datagram, but as a bit sequence outside the specification of a data transmission. Further preferably, individual bits are transported in frames on the data connection in accordance with a transport protocol used, wherein the signal comprises a message that is longer than a permissible frame. If for example a serial bus in accordance with RS-232 is operated in an 8N1 installation (8 data bits, no parity bit, one stop bit), so that a frame comprises 10 bits, the signal can be formed by 11 or more 0-bits in sequence.

It is particularly preferred that the control component is embodied as an integrated circuit. The circuit can be produced inexpensively in large quantities. Different components of a household appliance can easily each be fitted with such a circuit and connected communicatively with one another. Data can thereby be exchanged between the components, in order to enable a concerted operation of the components. Additionally, some or all components can support different modes that are associated with different levels of functions of the household appliance. The power consumption of an included control component can be reduced on average over time. The household appliance can thereby convert less electrical energy.

In accordance with a further aspect of the present invention, a control device includes a control component described herein and a device for controlling the function of the household appliance. The device can in particular control a utility function or an interaction with an operator. The utility function can include the control of an electrical consumer of the household appliance, for example a motor, a pump, a heater, a light or a compressor.

In accordance with a further aspect of the present invention, a system comprises two control components described herein and a data connection between the control components. One or both control devices can also be replaced by a control component described herein.

In accordance with yet another further aspect of the invention, a control device for a household appliance includes a control component described herein and a controller for the function of the household appliance.

In accordance once again with a further aspect of the present invention, a household appliance includes two or more control devices described herein and a data connection between the control devices or between the respectively comprised control components.

In accordance with yet another further aspect of the present invention, a method for controlling a control device to control a function of a household appliance includes steps for detecting a predetermined signal on a data connection which is connected to a further control device of the household appliance; wherein the signal is different from data that can be transmitted between two control components; and steps for enabling the control of the function. A corresponding method can be provided for the provision of the signal. In a preferred form of embodiment the control of the function is enabled only if a supply voltage of the control device is above a predetermined threshold value.

A control component described herein or a control device described herein can be designed to execute a method described herein in whole or in part. To this end the control component or the control device can comprise a programmable microcomputer or microcontroller and the method can take the form of a computer program product with program code means. The computer program product can also be stored on a computer-readable data carrier. Features or advantages of the method can be transferred to the device or vice versa.

The invention is now described in greater detail with reference to the accompanying figures, in which:

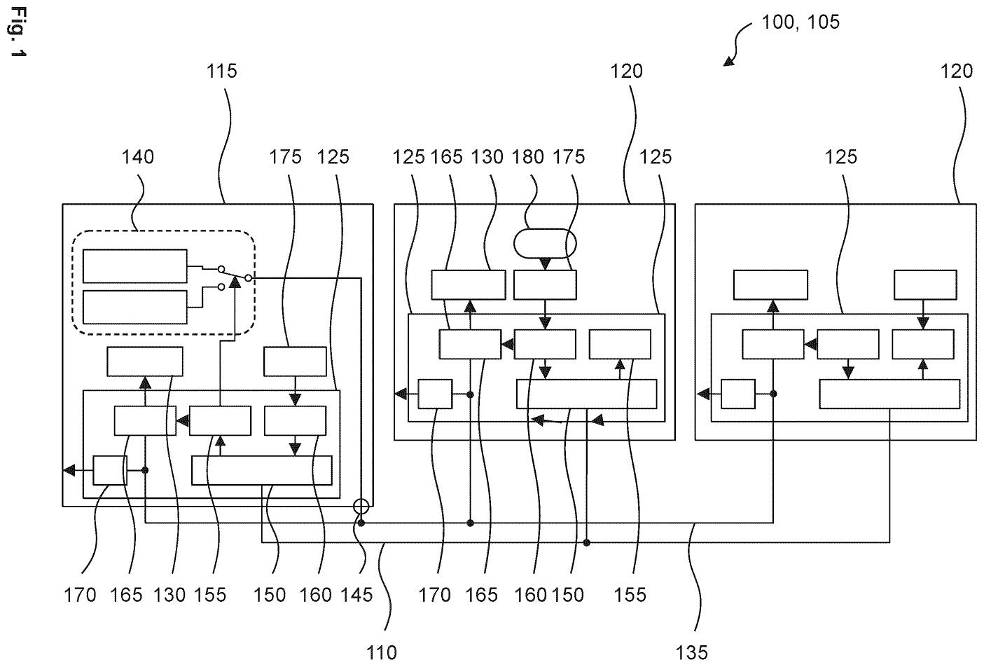

FIG. 1 shows a household appliance;

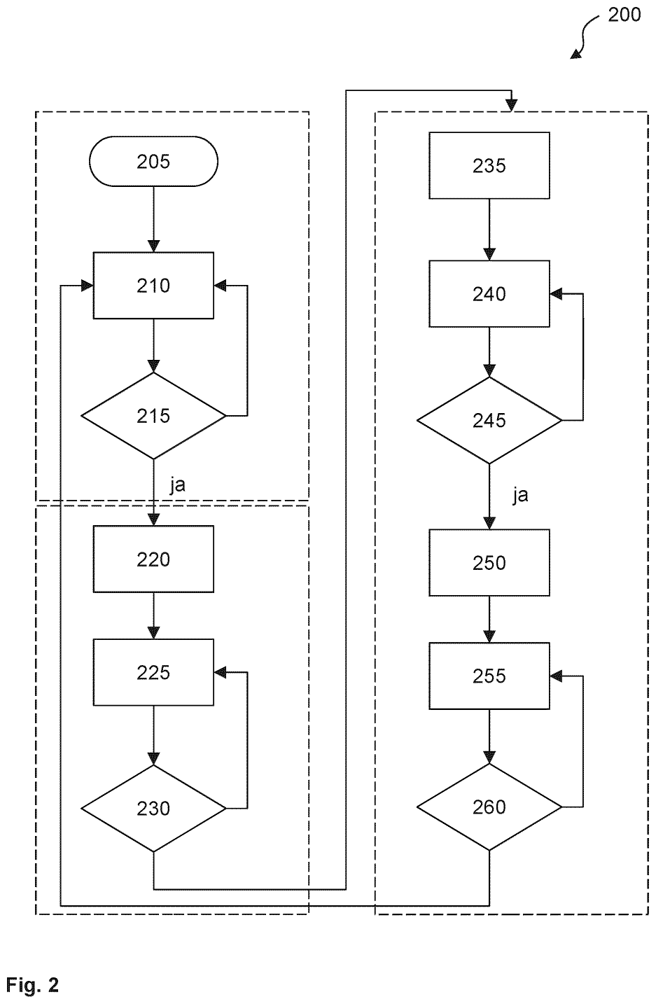

FIG. 2 shows a flow diagram of a first method; and

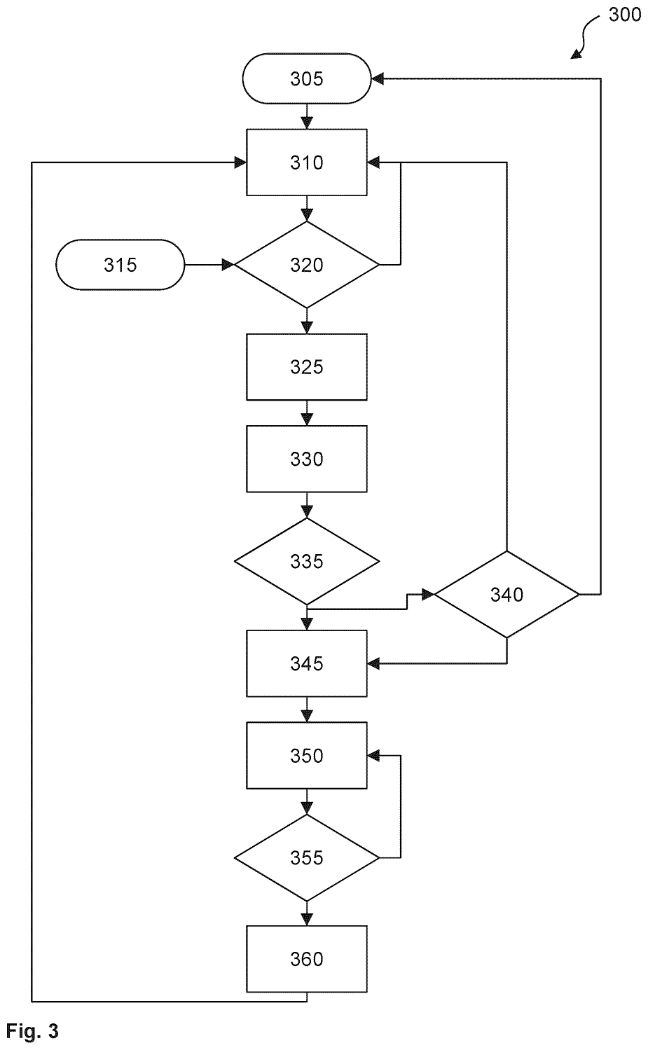

FIG. 3 shows a flow diagram of a second method.

FIG. 1 shows a household appliance 100, which may for example comprise a dishwasher, a vacuum cleaner, a stove or a laundry care appliance, such as a washer-dryer or a washing machine. The household appliance 100 is designed for use in a household.

The household appliance 100 comprises a system 105 of multiple control devices, connected to one another by means of a data connection 110. In this case a first control device 115 and multiple second control devices 120 are shown. In other forms of embodiment more or fewer than the two second control devices 120 shown may also be provided. Each control device 115, 120 comprises a control component 125 and an optional device 130 for controlling a function of the household appliance 100. If no dedicated device 130 is provided, the function can be controlled directly by the control component 125. A function can relate to a predetermined component of the household appliance 100, for example a pump, a valve, a drive motor, a heater or a user interface. A device 130 can also control multiple functions of the household appliance. Multiple functions are normally necessary in order to operate the household appliance 100.

The data connection 110 preferably comprises a data bus, in particular a serial data bus, for example in accordance with RS-485, and permits the transmission of data between two control devices 115, 120, for example to coordinate the controllers for different functions of the household appliance 100.

A control component 125 is designed to control a mode of the respective control device 115, 120 that reflects its level of activity. For the present description a standby mode and an operating mode are initially assumed; further modes May additionally be possible.

Modes of the control devices 115, 120 are preferably coordinated with one another. In respect of the description for FIG. 1 it is assumed, without limiting the generality, that the first control device 115 determines a mode, so that it can also be referred to as a specifier, and that the second control devices 120 follow this operating mode, so that they can also be referred to as followers.

A supply line 135 is preferably provided, which runs from the first control device 115 to all second control devices 120. The first control device 115 preferably comprises a voltage controller 140, which for example comprises two voltage sources for the provision of differently high voltages, and a changeover switch. The voltage controller 140 is designed to provide a voltage on which multiple control components 125 can be operated and can be implemented for example by means of a switching regulator that appropriately converts energy from a supply network.

By means of the voltage controller 140 a higher voltage, for example approx. 5 V, or a lower voltage, for example approx. 2.7 V, can be provided at an output 145 of the first control device 115. The voltage provided can be used to supply control components 125 of the second control devices 120 and optionally also the control component 125 of the first control device 115 via the supply line 135. In a further form of embodiment the voltage controller 140 can also be actuated to reduce the supply voltage to zero. Second control devices 120 connected to the voltage supply 140 can thus be switched off completely. Thus the second control device 120 can be put into an awake mode by means of the higher voltage, into a standby mode by means of the lower voltage and into a switched-off mode by means of a switched-off voltage. In this case the first control device 115 is preferably supplied with current from a source other than the voltage supply 140, so that it can also work in this case. In yet another form of embodiment further voltages can be brought about by means of the voltage supply 140, wherein each voltage is assigned an activity mode of a connected first or second control device 115, 120.

A control device 115, 120 can be designed to store an internal mode, such that it is retained even when the supply voltage is low or switched off. The mode can for example comprise addressing the control device 115, 120 for the data connection 110. To administer the mode an assigned parameter can for example be written to a nonvolatile memory or read out therefrom.

The control component 125 is preferably embodied as an integrated circuit. Identical versions of a control component 125 can be used in all first and second control devices 115, 120. However, in this case not all functions of the control component 125 need be used in all control devices 115, 120.

The control component 125 preferably comprises a bus connection 150, a signal detector 155, a signal generator 160, monitoring 165 for the supply voltage and a voltage regulator 170. The bus connection 150 is connected to the data connection 110 and is preferably designed to read data from the data connection or to write data to it. Data that has been read can itself be processed or passed to the device 130 and data to be written can itself be generated or received by the device 130.

To transmit data, use can be made of a predetermined communication protocol on the physical layer. Data to be transmitted is in this case preferably transmitted in frames of a predetermined length, wherein a frame comprises a predetermined amount of useful data and a predetermined amount of administrative data. For example, a frame in 7E2 format can comprise useful data of 7 bits, an even parity bit and 2 stop bits. The bus connection 150 can for example comprise a communication module of the UART type (universal asynchronous receiver and transmitter), which can be configured to a desired frame format.

The signal detector 165 is designed to detect a predetermined signal on the data connection 110, wherein the signal is different from transmissible data. In particular, the predetermined signal can comprise a longer bit sequence than can be formed by a valid frame. If the signal detector 165 on the data connection 110 detects the predetermined signal, the monitoring 165 can be actuated to enable the function. To this end the device 130 can be actuated accordingly.

The monitoring 165 is connected to the supply line 135 and is designed to determine whether a predetermined high or a predetermined low voltage is present there. To this end the monitoring 165 can compare the voltage with one or two threshold values. If the monitoring 165 determines that sufficient voltage is present, the function can be enabled. The function is preferably enabled only if the signal has also been detected by the signal detector 165.

The voltage regulator 170 is designed to provide, on the basis of the voltage present on the supply line 135, an operating voltage that is necessary for the operation of the control component 125 and/or the device 130. The voltage regulator can implement step-down regulation with a low voltage difference (low drop voltage controller, low drop out, LDO). The difference between an input voltage and an output voltage is in this case typically less than 1 V.

The control component 125 and the device 130 are preferably designed to go into a standby mode if their operating voltage is below a predetermined voltage, and otherwise to execute an operating mode.

The signal generator 160 is designed to apply the predetermined signal to the data connection 110. To this end it is possible to wait until a communication that is currently taking place has been terminated or the signal can be superimposed on the communication. The signal can be sent on the basis of different events. For example, by means of a detection device 175 a request to leave standby mode can be detected by a component of the control device 115, 120. The detection device 175 can determine an external event 180, for example an input by a user, a breach of a threshold value by a measured value or an expiration of a predetermined period of time. The request can also be determined by the control component 125, for example by means of an internal timer or because a condition has been fulfilled. The device 130 too can pass a request to cancel the standby mode to the control component 125.

The standby mode can be activated if a predetermined condition is fulfilled. It is preferable to wait until the condition has been fulfilled for a predetermined period of time. Thus the standby mode can for example be initiated if there has been no input from a user for approx. 10 or 20 s. The standby mode can also be requested in another way, for example by a predetermined input by the user or the fulfillment of a predetermined internal condition. In a further form of embodiment the standby mode can be requested by the device 130.

If the control devices 115, 120 are in standby mode, the voltage on the supply line 135 is low. The standby mode can be switched to operating mode if a predetermined event occurs or a predetermined condition is fulfilled. To this end the first control device 115 can increase the voltage of the supply line 135 by means of the voltage controller 140. A second control device 120 can apply the predetermined signal to the data connection 110. The signal is then determined by the first control device 115, whereupon this increases the voltage of the supply line 135 as described. The monitors 165 of all the control components 125 determine the higher voltage and supply the local control component 125 and/or the local device 130 with a higher voltage, so that these enter into the operating mode. The transition to standby mode can be determined and initiated by the control component 125 of the first control device, by reducing the voltage of the supply line 135.

It is also possible for the transition between standby mode and operating mode to comprise a communication between individual control devices 115, 120. In this case additional operating modes can be controlled or it can be determined which second control device 120 will take part in an impending change in the operating mode.

FIG. 2 shows a flow diagram of a first method for controlling a first control device 115 or the control component 125 thereof. In a step 205 the control component 125 can be reset, for example when switching on the complete household appliance 100. In a step 210 the control component 125 is then in standby mode. In a step 215 it is possible to check whether a condition has been fulfilled in order to exit standby mode. The condition can in particular comprise the receipt of the predetermined signal on the data connection 110. If the condition is not fulfilled, the step 210 can be carried out afresh. The steps 205 to 215 can form a first mode which corresponds to the standby mode of the first control device 115.

If in step 215 the condition is determined as fulfilled, the transition to the operating mode can be initiated in a step 220. To this end it is possible to control an increase in the voltage on the supply line 135. In a step 225 it is possible to wait for a predetermined time and in a step 230 the voltage of the supply line can be checked. If this is in the range of the low voltage, it is possible to branch back to step 225. The steps 215 to 230 can form a second mode, which corresponds to the transition of the first control device 115 from standby mode to operating mode.

If in step 230 a higher voltage was determined on the supply line 135, then the function of the first control device 115 can be enabled in a step 235. The function can then be executed by the device 130 or by the control component 125. In a step 240 it is possible to wait for a predetermined time before checking in a step 245 whether a transition to standby mode was requested. Such a request can exist if an associated predetermined condition is fulfilled, for example the expiration of a predetermined time. If no request was determined, it is possible to branch back to step 240. The steps 235 to 240 can form a third mode, which corresponds to the operating mode of the first control device 115.

If it was determined in step 245 that a request for standby mode exists, then in a step 250 the system 105 can be switched to standby mode. To this end the voltage controller 140 can be actuated to reduce the voltage of the supply line 135. In a step 255 it is possible to wait for a predetermined time before the level of the voltage on the supply line 135 is determined in a step 260. If this is in the range of a low voltage, it is possible to branch back to step 210. The steps 215 to 230 can form a fourth mode, which corresponds to the transition of the first control device 115 from standby mode to operating mode.

FIG. 3 shows a flow diagram of a second method 300 for controlling a second control device 120 or the control component 125 thereof. In a step 305 it is possible to reset the control component 125, cf. step 205. In a step 210 the control component 125 is in standby mode, cf. step 210. In a step 315 a predetermined event occurs or a predetermined condition is present. In a step 320 the event or the fulfillment of the condition is determined. In the negative case it is possible to branch back to step 310. The steps 305 to 320 can form a first mode, which corresponds to the standby mode of the second control device 120.

If in step 310 the event or the fulfilled condition was determined, then in a step 325 a predetermined signal can be applied to the data connection 110, in order to switch the system 105 to operating mode. In a step 330 it is possible to wait for a predetermined time before the voltage on the supply line is checked in a step 335. If this is in the range of a low voltage, it is possible to branch back to step 330.

If in step 335 it was determined that the voltage on the supply line 135 is high, then in a step 340 an extended control can be carried out, if the control component 125 is designed or configured for this. The extended control can comprise a diagnosis, a test mode or the assumption of a further operating mode. The control component 125 can then be reset, by branching to step 305, or can be put into standby mode, by branching to step 310.

The steps 325 to 340 can form a second mode, which corresponds to the transition of the second control device 120 from standby mode to operating mode.

Following step 335 or 340 it is possible to proceed to step 345, in which the function of the second control device 120 is enabled, cf. step 235. In a step 350 it is possible to wait for a predetermined time before in a step 355 it is determined whether a transition to standby mode was requested. To this end in particular the occurrence of a local event, the fulfillment of a condition or the receipt of a predetermined message can be determined. In the negative case it is possible to branch back to step 355. The steps 345 to 355 can form a third mode, which corresponds to the operating mode of the second control device 120.

If in step 355 it was determined that the standby mode was requested, the control component 125 can switch to standby mode. A message can optionally be sent beforehand to one or more control devices 115, 120, in which the transition is announced. Another control device 115, 120 can then likewise switch itself to standby mode, cf. step 355. It is then possible to branch back to step 310. Step 360 can form a fourth mode, which corresponds to the transition of the second control device to standby mode.

### REFERENCE CHARACTERS

100 Household appliance
105 System
110 Data connection
115 First control device (specifier)
120 Second control device (follower)
125 Control component
130 Device
135 Supply line
140 Voltage controller
145 Output
150 Bus connection
155 Signal detector
160 Signal generator
165 Monitoring the supply voltage
170 Voltage regulator
175 Detection device
180 Event
200 Method
205 Reset
210 Control component in standby mode
215 Signal detected?
220 Switch control device to operating mode
225 Wait
230 Check supply voltage
235 Enable function
240 Wait
245 Standby mode requested?
250 Switch control device to standby mode
255 Wait
260 Check supply voltage
300 Method
305 Reset
310 Control device in standby mode
315 Event
320 Event detected?
325 Generate signal
330 Wait
335 Check supply voltage
340 Extended control
345 Enable function
350 Wait
355 Standby mode requested?
360 Switch to standby mode

1-13. (canceled)

14. A control component for a household appliance, the control component comprising:
an interface for a data connection to a further control component of the household appliance;
a detector for detecting a predetermined signal on the data connection, the predetermined signal being different from data that can be transmitted between the control component and the further control component;
an input for a supply voltage; and
a first output for enabling control of a function of the household appliance in dependence upon a voltage that is present at the input.

15. The control component according to claim 14, further comprising a second output for outputting a supply voltage for the further control component, and wherein the control component is configured to provide a high voltage or a low voltage at said second output.

16. The control component according to claim 14, further comprising a generator for the signal on the data connection in dependence upon a predetermined condition.

17. The control component according to claim 16, further comprising a detector for detecting a signal that represents a fulfillment of the predetermined condition.

18. The control component according to claim 14, further comprising a voltage controller for providing the supply voltage for control of the function on a basis of the supply voltage that is present at the input.

19. The control component according to claim 18, wherein said voltage controller is configured to selectively provide a high voltage or a low voltage.

20. The control component according to claim 14, wherein the control component is configured to provide data on said data connection for controlling an operating mode of the further control component.

21. The control component according to claim 14, wherein said data connection comprises a bus.

22. The control component according to claim 14 configured as an integrated circuit.

23. A control device for a household appliance, the control device comprising a control component according to claim 14 and a controller for controlling a functionality of the household appliance.

24. A system, comprising two control components each being a control component according to claim 14, and a data connection between said two control components.

25. A household appliance, comprising two control devices each including a control component according to claim 14 and a controller for controlling a function of the household appliance, and a data connection between said control components of said two control devices.

26. A method for controlling a control device for controlling a function of a household appliance, the method comprising the following steps:
detecting a predetermined signal on a data connection, which is connected to a further control device of the household appliance;
wherein the signal is different from data that can be transmitted between two control components of the household appliance; and
enabling a control of the function of the household appliance.
